(19) United States
(12) Patent Application Publication
(10) Pub. No.: US 2010/0267360 A1
(43) Pub. Date: Oct. 21, 2010

(54) METHOD AND SYSTEM OF STARTING VOICE CALL

(75) Inventors: YI-FANG WU, Tu-Cheng (TW); YE YUAN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 12/489,842

(22) Filed: Jun. 23, 2009

(30) Foreign Application Priority Data
Apr. 17, 2009 (CN) 200910301640.5

(51) Int. Cl. H04M 11/04; H04W 4/02

(52) U.S. Cl. 455/404.2; 455/414.1

(57) ABSTRACT

A method of starting voice call is disclosed. The method includes capturing a location information of a mobile phone by a global positioning system (GPS). A text to speech conversion module converts the location information to a voice file. A phone plays the voice file to a remote phone terminal.

### BACKGROUND

1. Technical Field

The present disclosure relates to a method and system of starting voice call and, particularly, to a method and system of automatically starting voice call by phone.

2. Description of Related Art

Telephones are widely used. But a user may not always be in condition to dial a telephone number, particularly in an emergency. For example, if the user in a traffic accident and is rendered unconscious.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a system of starting voice call; and

FIG. 2 is a flowchart of a method of starting voice call.

### DETAILED DESCRIPTION

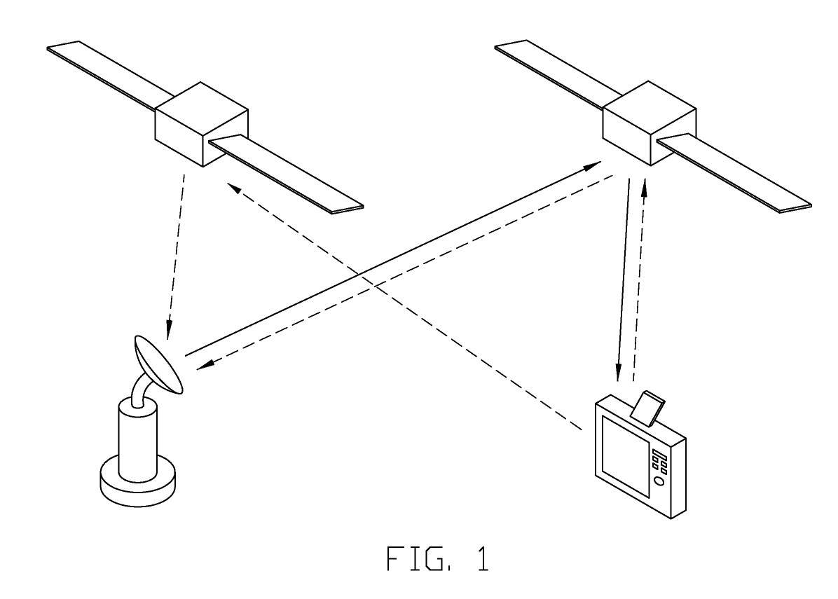

Referring to FIG. 1, a system of starting voice call connects with a Global Positioning System (GPS). The GPS uses a constellation of between 24 and 32 medium Earth orbit satellites that transmit precise radiowave signals, which allow GPS receivers to determine their current location, the time, and their velocity.

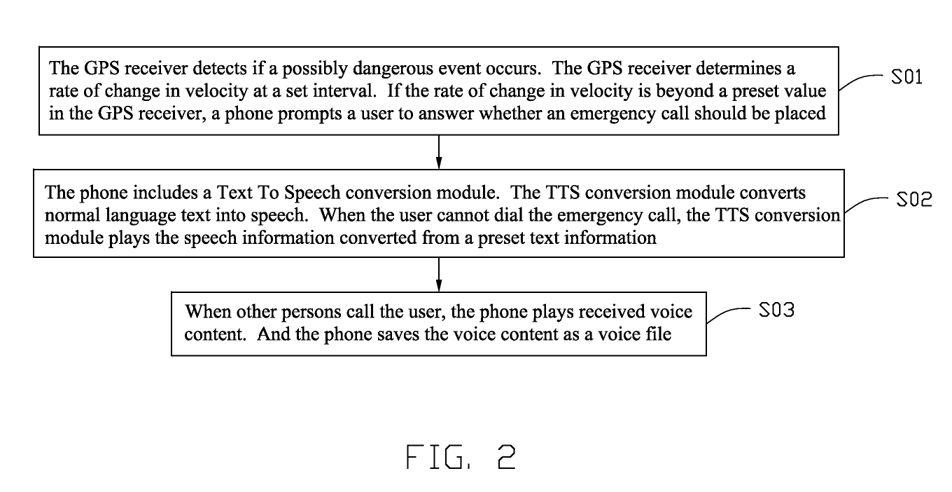

Referring to FIG. 2, a flowchart of a method of starting voice call is disclosed. In step S01, the GPS receiver (detecting module) detects if a possibly dangerous event occurs. The GPS receiver determines a rate of change in velocity at a set interval. If the rate of change in velocity is beyond a preset value in the GPS receiver, a phone prompts a user to answer whether an emergency call should be placed. If the user does not confirm, a call may be placed to a default emergency number. If the user confirms, the phone then prompts the user to select a contact from a contact list in the phone. If the user cannot select the contact within three minutes (for example, the user is unconscious), the phone automatically dials the emergency call to, for example, a police station or hospital. If the user cannot confirm to dial the emergency call in three minutes, the phone automatically dials the emergency call. Three minutes is an arbitrary number and can be set to any time duration.

In step S02, the phone includes a Text To Speech (TTS) conversion module. The TTS conversion module converts normal language text into speech. When the user cannot dial the emergency call, the TTS conversion module plays the speech information converted from a preset text information. For example, “Hello, this is Eric. I live in Donghuan Road, Longhua Town, Bao'an District, Shenzhen City. I am now on Meilong Road, Longhua Town, Bao'an District, Shenzhen City. I may have encountered a traffic accident or other emergency situation. This call is automatically dialed by my phone. Please help me. My ID number is 123456789. I will try to send a message.” The speech information will be repeated many times. A language broadcast by the TTS conversion module is provided according to a country of the current location of the user.

In step S03, when other persons call the phone that is in emergency status, the phone plays received voice content. And the phone saves the voice content as a voice file.

The system of starting voice call may include other functions. For example, a notify home function. When it is inconvenient for a user to talk and they will be home late or want to let home know where they are, the user can select the notify home function. The phone automatically dials a phone number for home. The GPS receiver determines the user's location. The TTS conversion module converts the user's location and preset voice content to a voice file to play.

The user may edit a short message. When the user dials the phone number, the phone may play a voice file converted from the short message and the user's location. The phone may include a blood sensor for detecting a blood concentration in air around the GPS receiver. The GPS receiver can determine if there is an emergency event through the blood concentration in air. If the blood concentration in air is beyond a preset value, the phone automatically places the emergency call.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method of starting voice call, comprising:
capturing a location information of a mobile phone by a global positioning system (GPS);
converting the location information to a voice file through a text to speech conversion module; and
playing the voice file to a remote phone terminal.

2. The method of claim 1, wherein when a change rate of velocity of the mobile phone beyond a preset change rate is detected, a detecting module is triggered to capture the location information.

3. The method of claim 1, wherein when a value of blood concentration in air beyond a preset value is detected, a detecting module is triggered to capture the location information.

4. The method of claim 1, wherein the location information comprises a country information of the location, and the voice file is capable of being translated to another voice file in a language of the country.

5. The method of claim 1, further comprising playing a recorded information to the remote phone terminal when the mobile phone is in an emergency state.

6. A system of starting voice call, comprising:
a positioning module capable of capturing a current location information;
a text to speech conversion module capable of converting the current location information to a voice file; and
a phone capable of dialing a preset phone number and then playing the voice file to a remote phone terminal.

7. The system of claim 6, wherein a detecting module detects a change rate of velocity of the phone beyond a preset change rate to capture the current location information.

8. The system of claim 6, wherein a detecting module detects a value of blood concentration in air beyond a preset value to capture the current location information.

9. The system of claim 6, wherein the current location information comprises a country information, and the voice file is played as a language of the country information.

10. The system of claim 6, wherein the positioning module is a global positioning system for positioning through secondary planet.

11. The system of claim 6, wherein the phone plays a recorded information to the remote phone terminal when the phone is in an emergency state.
